(19) United States
(12) Patent Application Publication
(10) Pub. No.: US 2026/0140487 A1
(43) Pub. Date: May 21, 2026

(54) CONTROLLING SOFTWARE REMOTE CENTERS OF MOTION FOR COMPUTER-ASSISTED SYSTEMS SUBJECT TO MOTION LIMITS

(71) Applicant: INTUITIVE SURGICAL OPERATIONS, INC., Sunnyvale, CA (US)

(72) Inventors: Amin ZEIAEE, Los Gatos, CA (US); Goran A. LYNCH, Alpine Meadows, CA (US)

(21) Appl. No.: 19/121,707

(22) PCT Filed: Oct. 16, 2023
(86) PCT No.: PCT/US2023/035251

§ 371 Date: Apr. 16, 2025

Related U.S. Application Data
(60) Provisional application No. 63/416,877, filed on Oct. 17, 2022.

(51) Int. Cl. G05B 15/02

(52) U.S. Cl. CPC G05B 15/02

(57) ABSTRACT

A computer-assisted system includes a repositionable structure configured to support an instrument and a control unit. The control unit is configured to: while a remote center of motion (RCM) is set at a first position, receive a command to move the repositionable structure with a commanded motion; determine whether driving the plurality of joints to move the repositionable structure in accordance with the commanded motion while maintaining the remote center of motion RCM at the first position would violate a limit of the repositionable structure; and, in response: determine an alternative motion of the plurality of joints based on the commanded motion and the first position, wherein driving the plurality of joints in accordance with the alternative motion would not violate the limit, and would move the RCM to a second position different from the first position, and drive the plurality of joints in accordance with the alternative motion.

### RELATED APPLICATIONS

This application claims the priority benefit to U.S. Provisional Application No. 63/416,877, filed Oct. 17, 2022, and entitled “Controlling Software Remote Centers of Motion for Computer-Assisted Systems Subject to Motion Limits,” which is incorporated by reference herein.

### TECHNICAL FIELD

The present disclosure relates generally to computer-assisted systems and more particularly to controlling software remote centers of motion for computer-assisted systems subject to motion limits.

### BACKGROUND

Computer-assisted systems are often used to perform or assist procedures in a workspace. In an example computer-assisted system with teleoperation, an operator at a user input system manipulates a leader device (e.g., an input device configured to accept commands for a follower device) to cause motions of a follower device (e.g., a manipulating assembly that can be teleoperated, and comprising a repositionable structure with or without a supported instrument). In an example, motions of the leader device relative to an operator frame of reference are used to determine corresponding motion commands for the follower device relative to a field of view of an imaging device.

In some examples, a computer-assisted system comprises a repositionable structure with a remote center of motion (RCM) enforced by the hardware design of the repositionable structure, such that a point on a cannula, guide tube, or entry guide, experiences little to no motion during a procedure performed by the repositionable structure. That is, this “hardware” RCM experiences little to no motion during a task performed by the repositionable structure because the joints that are driven to enable the repositionable structure to perform the task are physically designed to avoid moving this hardware RCM.

In some instances, it may be desirable to drive a repositionable structure with a hardware RCM to pivot about an RCM set at positions not collocated with the hardware RCM. In such instances, the human operator could set a virtual (or software) RCM, which is different from the hardware RCM. In some instances, it may be desirable to drive a repositionable structure that includes an arrangement of links and joints that does not provide a hardware RCM. In such instances, the human operator could set a software RCM, in order to define a location that experiences little to no motion during a procedure.

Accordingly, improved techniques for controlling repositionable systems with software remote centers of motion are desirable.

### SUMMARY

Consistent with some embodiments, a computer-assisted system, and method implemented therein, includes a repositionable structure configured to support an instrument, the repositionable structure comprising a plurality of links coupled by a plurality of joints; and a control unit communicatively coupled to the repositionable structure. The control unit is configured to, while a remote center of motion (RCM) is set at a first position, receive a command to move the repositionable structure with a commanded motion. The control unit is further configured to determine whether driving the plurality of joints to move the repositionable structure in accordance with the commanded motion while maintaining the remote center of motion RCM at the first position would violate a limit of the repositionable structure. The control unit is further configured to in response to a determination that driving the plurality of joints to move the repositionable structure in accordance with the commanded motion while maintaining the RCM at the first position would violate the limit: determine an alternative motion of the plurality of joints based on the commanded motion and the first position, wherein driving the plurality of joints in accordance with the alternative motion would not violate the limit, and would move the RCM to a second position different from the first position, and drive the plurality of joints in accordance with the alternative motion.

Consistent with some embodiments, a method of driving a plurality of joints of a repositionable structure includes, while a remote center of motion (RCM) is set at a first position, receiving a command to move an instrument with a commanded motion. The method further includes determining whether driving the plurality of joints to move the repositionable structure in accordance with the commanded motion while maintaining the RCM at the first position would violate a limit of the repositionable structure. The method further includes, in response to determining that driving the plurality of joints to move the repositionable structure in accordance with the commanded motion while maintaining the RCM at the first position would violate the limit: determining an alternative motion of the plurality of joints based on the commanded motion and the first position, wherein driving the plurality of joints in accordance with the alternative motion would not violate the limit, and would move the RCM to a second position different from the first position, and driving the plurality of joints in accordance with the alternative motion.

Consistent with some embodiments, one or more non-transitory machine-readable media include a plurality of machine-readable instructions which when executed by one or more processors are adapted to cause the one or more processors to perform any of the methods described herein.

### BRIEF DESCRIPTION OF THE DRAWINGS

FIG. 1 is a diagram of a computer-assisted system in accordance with one or more embodiments.

FIG. 2 is a diagram of a computer-assisted system in accordance with one or more embodiments.

FIG. 3A is a flow diagram of method steps for moving a software RCM with a plastic kinematic constraint and associated with a repositionable structure in accordance with one or more embodiments.

FIG. 3B is a flow diagram of method steps for moving a software RCM with an elastic kinematic constraint and associated with a repositionable structure in accordance with one or more embodiments.

FIGS. 4A-4D illustrate movement of a software RCM with a plastic kinematic constraint in accordance with one or more embodiments.

FIGS. 5A-5D illustrate movement of a software RCM with an elastic kinematic constraint in accordance with one or more embodiments.

In the figures, elements having the same designations have the same or similar functions.

### DETAILED DESCRIPTION

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Further, the terminology in this description is not intended to limit the invention. For example, spatially relative terms-such as “beneath”, “below”, “lower”, “above”, “upper”, “proximal”, “distal”, and the like-may be used to describe the relation of one element or feature to another element or feature as illustrated in the figures. These spatially relative terms are intended to encompass different positions (i.e., locations) and orientations (i.e., rotational placements) of the elements or their operation in addition to the position and orientation shown in the figures. For example, if the content of one of the figures is turned over, elements described as “below” or “beneath” other elements or features would then be “above” or “over” the other elements or features. Thus, the exemplary term “below” can encompass both positions and orientations of above and below. A device may be otherwise oriented (rotated 90 degrees or at other orientations) and the spatially relative descriptors used herein interpreted accordingly. Likewise, descriptions of movement along and around various axes include various special element positions and orientations. In addition, the singular forms “a”, “an”, and “the” are intended to include the plural forms as well, unless the context indicates otherwise. And, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components.

Elements described in detail with reference to one embodiment, implementation, or module may, whenever practical, be included in other embodiments, implementations, or modules in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, implementation, or application may be incorporated into other embodiments, implementations, or aspects unless specifically described otherwise, unless the one or more elements would make an embodiment or implementation non-functional, or unless two or more of the elements provide conflicting functions.

In some instances, well known methods, procedures, components, and circuits have not been described in detail so as not to unnecessarily obscure aspects of the embodiments.

This disclosure describes various devices, elements, and portions of computer-assisted systems and elements in terms of their state in three-dimensional space. As used herein, the term “position” refers to the location of an element or a portion of an element (e.g., three degrees of translational freedom in a three-dimensional space, such as along Cartesian x-, y-, and z-coordinates). As used herein, the term “orientation” refers to the rotational placement of an element or a portion of an element (e.g., three degrees of rotational freedom in three-dimensional space, such as about roll, pitch, and yaw axes, represented in angle-axis, rotation matrix, quaternion representation, and/or the like). As used herein, and for a device with a kinematic series, such as with a repositionable structure with a plurality of links coupled by one or more joints, the term “proximal” refers to a direction toward a base of the kinematic series, of and “distal” refers to a direction away from the base along the kinematic series.

As used herein, the term “pose” refers to the multi-degree of freedom (DOF) spatial position and orientation of a coordinate system of interest attached to a rigid body. In general, a pose includes a pose variable for each of the DOFs in the pose. For example, a full 6-DOF pose for a rigid body in three-dimensional space would include 6 pose variables corresponding to the 3 positional DOFs (e.g., x, y, and z) and the 3 orientational DOFs (e.g., roll, pitch, and yaw). A 3-DOF position only pose would include only pose variables for the 3 positional DOFs. Similarly, a 3-DOF orientation only pose would include only pose variables for the 3 rotational DOFs. Further, a velocity of the pose captures the change in pose over time (e.g., a first derivative of the pose). For a full 6-DOF pose of a rigid body in three-dimensional space, the velocity would include 3 translational velocities and 3 rotational velocities. Poses with other numbers of DOFs would have a corresponding number of velocities translational and/or rotational velocities.

Aspects of this disclosure are described in reference to computer-assisted systems, which can include devices that are teleoperated, externally manipulated, autonomous, semiautonomous, and/or the like. Further, aspects of this disclosure are described in terms of an implementation using a teleoperated surgical system, such as the da Vinci® Surgical System commercialized by Intuitive Surgical, Inc. of Sunnyvale, California. Knowledgeable persons will understand, however, that inventive aspects disclosed herein may be embodied and implemented in various ways, including teleoperated and non-teleoperated, and medical and non-medical embodiments and implementations. Implementations on da Vinci® Surgical Systems are merely exemplary and are not to be considered as limiting the scope of the inventive aspects disclosed herein. For example, techniques described with reference to surgical instruments and surgical methods may be used in other contexts. Thus, the instruments, systems, and methods described herein may be used for humans, animals, portions of human or animal anatomy, industrial systems, general robotic, or teleoperated systems. As further examples, the instruments, systems, and methods described herein may be used for non-medical purposes including industrial uses, general robotic uses, sensing or manipulating non-tissue work pieces, cosmetic improvements, imaging of human or animal anatomy, gathering data from human or animal anatomy, setting up or taking down systems, training medical or non-medical personnel, and/or the like. Additional example applications include use for procedures on tissue removed from human or animal anatomies (with or without return to a human or animal anatomy) and for procedures on human or animal cadavers. Further, these techniques can also be used for medical treatment or diagnosis procedures that include, or do not include, surgical aspects.

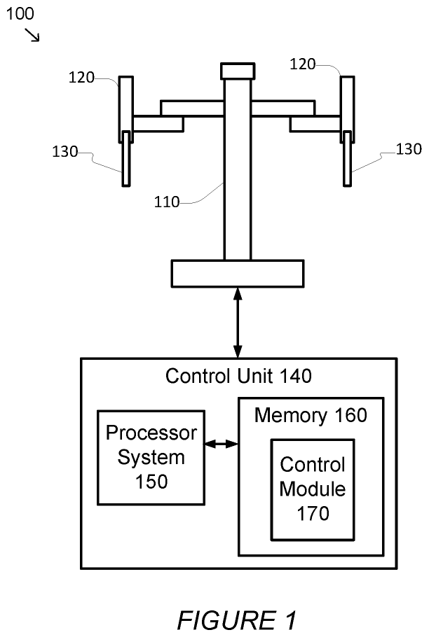

FIG. 1 is a diagram of a computer-assisted system 100 in accordance with one or more embodiments. As shown in FIG. 1, the computer-assisted system 100 includes a manipulating assembly 110 with one or more repositionable structures 120. In the example of FIG. 1, the repositionable structure(s) are shown as manipulator arms comprising a plurality of links coupled by one or more joints. Each of the one or more repositionable structures 120 can support one or more instruments 130. In some examples, the manipulating assembly 110 can comprise a computer-assisted surgical assembly. Examples of medical instruments include surgical instruments for interacting with tissue, imaging, sensing devices, and/or the like. In some examples, the instruments 130 can include end effectors that are capable of, but are not limited to, performing, gripping, retracting, cauterizing, ablating, suturing, cutting, stapling, fusing, sealing, etc., and/or combinations thereof.

In a teleoperation example, the manipulating assembly 110 can further be communicatively coupled by wired or wireless connection to a user input system (not shown). The user input system can include one or more input controls, also referred to herein as input devices, for operating the manipulating assembly 110, the one or more repositionable structures 120, and/or the instruments 130. In some examples, the one or more input controls can include kinematic series of links and one or more joint(s), one or more actuators for driving portions of the input control(s), robotic manipulators, levers, pedals, switches, keys, knobs, triggers, and/or the like.

In examples supporting external manipulation, the input controls can be located at the repositionable structure. As a specific example, the input controls can comprise joint sensors that detect joint deflection, and the computer-assisted system is configured to process certain joint deflections to be commands to move the joint.

The manipulating assembly 110 of FIG. 1 is coupled to a control unit 140 via an interface. The interface can be wired and/or wireless, and can include one or more cables, fibers, connectors, and/or buses and can further include one or more networks with one or more network switching and/or routing devices. Operation of the control unit 140 is controlled by a processor system 150. The processor system 150 can include one or more central processing units, multi-core processors, microprocessors, microcontrollers, digital signal processors, field programmable gate arrays (FPGAs), application specific integrated circuits (ASICs), graphics processing units (GPUs), tensor processing units (TPUs), and/or the like in the control unit 140. The control unit 140 can be implemented as a stand-alone subsystem and/or board added to a computing device or as a virtual machine. In some embodiments, the control unit 140 can be included as part of the user input system and/or the manipulating assembly 110, and/or be operated separately from, and in coordination with, the user input system and/or the manipulating assembly 110.

As one example, the manipulating assembly 110, the user input system, and/or the control unit 140 can correspond to the patient side cart, the surgeon console, and the processing units and associated software of da Vinci® Surgical System commercialized by Intuitive Surgical, Inc. of Sunnyvale, California. In some embodiments, manipulating assemblies with other configurations, such as fewer or more repositionable structures, different user input systems or input controls, different repositionable structure hardware, and/or the like, can comprise the computer-assisted system 100.

The memory 160 can be used to store software executed by the control unit 140 and/or one or more data structures used during operation of the control unit 140. The memory 160 can include one or more types of machine-readable media. Some common forms of machine-readable media can include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip, or cartridge, and/or any other medium from which a processor or computer is adapted to read.

As shown in the example of FIG. 1, the memory 160 includes a control module 170 that can be used to support autonomous, semiautonomous, and/or teleoperated control of the manipulating assembly 110. The control module 170 can include one or more application programming interfaces (APIs) for receiving position, motion, force, torque, and/or other sensor information from the manipulating assembly 110, the repositionable structures 120, and/or the instruments 130, for sharing position, motion, force, torque, and/or collision avoidance information with other control units regarding other devices, and/or planning and/or assisting in the planning of motion for the manipulating assembly 110 (such as motion of the repositionable structures 120), and/or the instruments 130. In some examples, the control module 170 further supports autonomous, semiautonomous, and/or teleoperated control of the manipulating assembly 110 and/or the instruments 130 during the performance of various tasks. And although the control module 170 is depicted as a software application, the control module 170 can optionally be implemented using hardware such as circuitry, software, and/or a combination of hardware and software.

In a teleoperation example for computer-assisted system 100, an input control comprises a leader device (also called a “master” device in industry), and the manipulating assembly 110 or a repositionable structure 120 (either supporting or not supporting an instrument 130) comprises a follower device (also called a “slave” device in industry). An operator can use the one or more input controls to generate user input signals in order to command motion of the manipulating assembly 110, such as by commanding motion of one or more repositionable structures 120 and/or instruments 130, in a leader-follower configuration. The leader-follower configuration is a type of teleoperation configuration, and is sometimes called a master-slave configuration in industry.

In some medical embodiments, the computer-assisted system 100 can be found in a clinic, diagnostic facility, an operating room, an interventional suite, or other medical environment. Although the computer-assisted system 100 is shown comprising one manipulating assembly 110 with two repositionable structures 120, each supporting a corresponding instrument 130, one of ordinary skill would understand that the computer-assisted system 100 can include any number of manipulating assemblies, each manipulating assembly can comprise one or more repositionable structures, and each repositionable structure can support one or more instruments, and that all of these elements may be similar or different in design from that specifically depicted in these figures. In some examples, each of the manipulating assemblies can include fewer or more repositionable structures, and/or support fewer or more instruments, than specifically depicted in these figures.

In some implementations, each of the one or more repositionable structures 120 comprises a plurality of joints, where the plurality of joints includes multiple joint sets of drivable joints. Drivable joints can be driven by actuators to move the joints, and thus move components physically coupled to the joints. A joint set includes one or more joints of the plurality of joints. In some embodiments, the joint(s) of a first joint set of drivable joints are mechanically constrained to produce motion that pivot an RCM-constrained link (e.g., a distal link) of the plurality of links of the repositionable assembly about a default RCM, or that translate the RCM-constrained link along a linear axis intersecting the default RCM. (i.e., the default RCM is a hardware RCM based on the physical configuration of the computer-assisted system 100 or, in the alternative, an initial software-based RCM for systems that do not have a hardware RCM.) Thus, the joint(s) of the first joint set, when driven to move the repositionable structure, do not translate this default RCM, such that the first joint set of drivable joints are physically designed not to move the default RCM.

The joint(s) of a second joint set of drivable joints of the repositionable structure, are mechanically capable of translating the default RCM. During some instances of operation, the first and second joint sets of drivable joints are driven at different times, such that the second joint set of drivable joints is not driven when the first joint set of drivable joints is driven. In an example where the second joint set is used for setup and the first joint set is used for performing a task, the system can drive the second joint set before the task is performed, to move and then locate the default RCM in space. In this example, the second joint set is then not driven to move the default RCM during the procedure, and the first joint set is driven to enable the repositionable structure to perform the procedure. In this example, the computer-assisted system uses a default RCM, and the position of the default RCM is held stationary during the procedure.

In some use cases, the default RCM can be placed at an entry into a workspace, such as an opening into a chamber or device, a surgical incision, a natural orifice such as a mouth or throat, and/or the like. End effectors of instrument(s) or repositionable structure(s) located distally from the default RCM are translated and rotated by driving the first joint set to produce pivoting motions about the default RCM.

In some instances, it is desirable to move the end effectors of instrument(s) or repositionable structure(s) in motions other than easily achievable with a stationary RCM. For example, some repositionable structure and/or instrument design may limit and/or constrain the ability of the end effectors to reach and interact with particular regions, such as regions that are too close to, or too far from, the default RCM. This limitation and/or constraint can be overcome in such implementations by re-locating the default RCM, such as by moving the default RCM to be further retracted from the entry (perhaps to reach regions closer to the entry) or to be further inserted into the entry or workspace (perhaps to reach regions further from the entry). However, in such examples locating the default RCM away from the entry into the workspace may cause undesirable motion of the repositionable structure (or an instrument supported by the repositionable structure) relative to the entry. For example, in some instances, lateral motion of the repositionable structure (or instrument) relative to the entry can cause undesirable collisions or applied forces with material near the entry. In a medical example, lateral motion of an instrument in a surgical incision can cause further tissue trauma. Further, in some examples, the ability to relocate the RCM dynamically can provide advantages such as greater end effector reach, greater overall range of motion, decreased motion relative to a position other than at the position of the default RCM (such as for collision avoidance), and/or the like.

Further, certain joints are mechanically constrained to maintain the RCM and are drivable by the computer-assisted system 100 to move the repositionable structure(s) while maintaining the RCM. Other joints are drivable by the computer-assisted system 100 to move the RCM, as described herein. The ability to drive the repositionable structure to pivot about RCMs other than a fixed hardware, or stationary, RCM can help increase range of movement, increase the flexibility and dexterity of the repositionable structure, save time, reduce power or energy required to move the repositionable structure, and the like. This configurable RCM is referred to herein as a software RCM.

In an example system, in order to achieve little to no motion of a software RCM as the system is moved, one or more joints of the repositionable structure move as needed to maintain the position of the software RCM. However, if the repositionable structure is constrained or limited from moving as needed to maintain the position of the software RCM, then the system may become unable to maintain the software RCM at the desired position.

More specifically, the limit can be one or more of various constraints. In some examples, the constraint can be a pose constraint of the repositionable structure, a velocity constraint of the repositionable structure, an acceleration constraint of the repositionable structure, a force constraint of the repositionable structure, a power constraint of the repositionable structure, and/or the like. In some examples, the constraint can be based on a physical design of a portion of the computer-assisted system other than the repositionable structure. In some examples, the constraint can be based on a pose of the portion of the computer-assisted system. In some examples, the constraint can be a motion limit based on a likelihood that the commanded motion is anticipated to cause collision between the repositionable structure and an object, or between the instrument and the object. In some examples, the constraint can be a boundary around an object in a workspace of the repositionable structure. In some examples, the constraint can be a boundary around a keep-out region of the workspace. In some examples, the constraint can be a motion limit based on a position or a speed of the repositionable structure.

In some use cases, the repositionable structure(s) can be configured to couple or not couple to an entry port, can optionally use a port other than a cannula, such as a guide tube, and/or the like. In some examples, the manipulating assembly can also include an arrangement of links and joints that does not provide a hardware RCM. In such examples, the entry port, guide tube, or other portion of the repositionable structure(s) can be placed at an entry into a workspace, such as an opening into a chamber or device, a surgical incision, a natural orifice such as a mouth or throat, and/or the like. The human operator could set a default RCM, in order to define a location that experiences little to no motion during a procedure. Repositionable structure(s) located proximal to the entry into the workspace are translated and rotated by driving one or more joints of the repositionable structure(s) to produce pivoting motions about the software RCM, which in turn can be used to change the position and/or orientations of the repositionable structure(s), such as one or more portions of various instruments that are located distal to the software RCM.

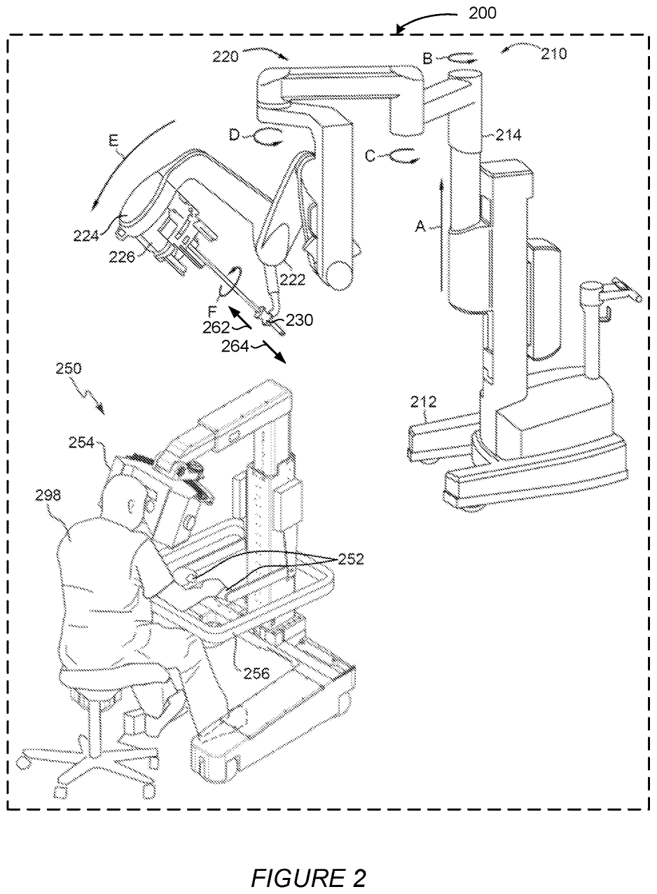

FIG. 2 is a diagram of a computer-assisted system 200 in accordance with one or more embodiments. The computer-assisted system 200, in the example of FIG. 2, includes a repositionable structure shown as a manipulating assembly 210 and a user input system 250. In a teleoperation scenario, an operator 298 can use the user input system 250 to generate user input signals to operate the manipulating assembly 210, such as in a leader-follower configuration. In the leader-follower configuration for the example of FIG. 1, a component of the user input system 250 (e.g., an input control device) is the leader, and a portion of the manipulating assembly 210 (e.g., a manipulator arm or other repositionable structure) is the follower.

The manipulating assembly 210 can be used to introduce a set of instruments to a work site through a single port 230 (e.g., using a cannula as shown) inserted in an aperture. In a medical scenario, the work site can be on or within a body of a patient, and the aperture can be a minimally invasive incision or a natural body orifice. The port 230 can be free-floating, held in place by a fixture, or held by a linkage 222. The linkage 222 can be coupled to additional joints and links 214, 220 of the manipulating assembly 210, and these additional joints and links 214, 220 can be mounted on a base 212. The linkage 222 can further include a manipulator-supporting link 224. A set of manipulators 226 can couple to the manipulator-supporting link 224. The repositionable structure that can be moved to follow commands from the user input system 250 can include one or more of any of the following: the linkage 222, additional joints and links 214, 220, base 212, manipulator-supporting link 224, and/or any additional links or joints coupled to the foregoing joints or links. Each of the manipulators 226 can include a carriage (or other instrument-coupling link) configured to couple to an instrument, and each of the manipulators 226 can include one or more joint(s) and/or link(s) that can be driven to move the carriage. For example, a manipulator 226 can include a prismatic joint that, when driven, linearly moves the carriage and any instrument(s) coupled to the carriage. This linear motion can be along (parallel to) an insertion axis that extends through port 230.

The additional joints and additional links 214, 220 can be used to position the port 230 at the aperture or another position. FIG. 2 shows a prismatic joint for vertical adjustment (as indicated by arrow “A”) and a set of rotary joints for horizontal adjustment (as indicated by arrows “B” and “C”) that can be used to translate a position of a default RCM. The linkage 222 is used to pivot the port 230 (and the instruments disposed within the port at the time) in yaw, pitch, and roll angular rotations about the default RCM located in proximity to port 230 as indicated by arrows D, E, and F, respectively, without translating the default RCM.

Actuation of the degrees of freedom provided by joint(s) of the instrument(s) can be provided by actuators disposed in, or whose motive force (e.g., linear force or rotary torque) is transmitted to, the instrument(s). Examples of actuators include rotary motors, linear motors, solenoids, and/or the like. The actuators can drive transmission elements in the manipulating assembly 210 and/or in the instruments to control the degrees of freedom of the instrument(s). For example, the actuators can drive rotary discs of the manipulator that couple with drive elements (e.g., rotary discs, linear slides) of the instrument(s), where driving the driving elements of the instruments drives transmission elements in the instrument that couple to move the joint(s) of the instrument, or to actuate some other function of the instrument, such as a degree of freedom of an end effector. Accordingly, the degrees of freedom of the instrument(s) can be controlled by actuators that drive the instrument(s) in accordance with control signals. The control signals can be determined to cause instrument motion or other actuation as determined automatically by the system, as indicated to be commanded by movement or other manipulation of the input control devices, or any other control signal. Furthermore, appropriately positioned sensors, e.g., encoders, potentiometers, and/or the like, can be provided to enable measurement of indications of the joint positions, or other data that can be used to derive joint position, such as joint velocity. The actuators and sensors can be disposed in, or transmit to or receive signals from, the manipulator(s) 226. Techniques for manipulating multiple instruments in a computer-assisted system are described more fully in U.S. Provisional Patent Application No. PCT/US 2021/047374, filed Aug. 24, 2021, and entitled “METHOD AND SYSTEM FOR COORDINATED MULTIPLE-TOOL MOVEMENT USING A DRIVABLE ASSEMBLY,” which is incorporated herein by reference.

While a particular configuration of the manipulating assembly 210 is shown in FIG. 2, those skilled in the art will appreciate that embodiments of this disclosure can be used with any design of manipulating assembly or other repositionable structure. In some examples, a manipulating assembly can have any number and any types of degrees of freedom, can be configured to couple or not couple to an entry port, can optionally use a port other than a cannula, such as a guide tube, and/or the like. In some examples, the manipulating assembly 210 can also include an arrangement of links and joints that does not provide a default RCM.

In the example shown in FIG. 2, the user input system 250 includes one or more input devices 252 configured to be operated by the operator 298. In the example shown in FIG. 2, the one or more input devices 252 are contacted and manipulated by the hands of the operator 298, with one input device for each hand. Examples of such hand-input-devices include any type of device manually operable by human user, e.g., joysticks, trackballs, button clusters, and/or other types of haptic devices typically equipped with multiple degrees of freedom. Position, force, and/or tactile feedback devices (not shown) can be employed to transmit position, force, and/or tactile sensations from the instruments back to the hands of the operator 298 through the input devices 252.

The input devices 252 are supported by the user input system 250 and are shown as mechanically grounded, and in other implementations can be mechanically ungrounded. An ergonomic support 256 can be provided in some implementations; for example, FIG. 2 shows an ergonomic support 256 including forearm rests on which the operator 298 can rest his or her forearms while manipulating the input devices 252. In some examples, the operator 298 can perform tasks at a work site near the manipulating assembly 210 during a procedure by controlling the manipulating assembly 210 using the input devices 252.

A display unit 254 is included in the user input system 250. The display unit 254 can display images for viewing by the operator 298. The display unit 254 can provide the operator 298 with a view of the worksite with which the manipulating assembly 210 interacts. The view can include stereoscopic images or three-dimensional images to provide a depth perception of the worksite and the instrument(s) of the manipulating assembly 210 in the worksite. The display unit 254 can be moved in various degrees of freedom to accommodate the viewing position of the operator 298 and/or to provide control functions. Where a display unit (such as the display unit 254 is also used to provide control functions, such as to command the manipulating assembly 210, the display unit also includes an input device (e.g., another input device 252).

When using the user input system 250, the operator 298 can sit in a chair or other support, position his or her eyes to see images displayed by the display unit 254, grasp and manipulate the input devices 252, and rest his or her forearms on the ergonomic support 256 as desired. In some implementations, the operator 298 can stand at the station or assume other poses, and the display unit 254 and input devices 252 can differ in construction, be adjusted in position (height, depth, etc.), and/or the like.

As described herein, the manipulating assembly 210 can optionally include a first joint set of drivable joints that are mechanically constrained to produce motion that does not translate the default RCM, such that the first joint set of drivable joints are not designed to move the default RCM. The manipulating assembly 210 further includes a second joint set of drivable joints that are mechanically capable of moving the default RCM. In some examples, the operator 298 may want to select an RCM relative to, such as a position located proximal to 262 or distal to 264, the default RCM. In order to reduce motion of the portion of the repositionable structure (and/or instrument supported by the repositionable structure) at the entry and/or to address the need to select a different RCM for other reasons, the disclosed embodiments allow for setting a virtual (or software) RCM at or near the entry where the software RCM is different from the default RCM. The disclosed embodiments utilize, as appropriate, motion in the second joint set in combination with motion in the first joint set to keep the software RCM at the selected position for the RCM. In some instances, a graphical user interface assists the operator 298 of the computer-assisted system in setting (registering for the system) the position of the software RCM. The graphical user interface further assists the operator 298 in determining the status of the software RCM, in terms of whether the software RCM has been set, whether a condition is inhibiting the ability of the repositionable structure to maintain the software RCM, and/or whether a condition affecting the software RCM has changed. In some examples, the operator 298 may want to drive a repositionable structure that includes an arrangement of links and joints that does not provide a default RCM. In such examples, the operator 298 can set a software RCM, in order to define a location that experiences little to no motion during a procedure. Techniques for setting and using a remote RCM in a computer-assisted system are described more fully in U.S. Provisional Ser. No. 63/324,587 , filed Mar. 28, 2022 and entitled “SETTING AND USING SOFTWARE REMOTE CENTERS OF MOTION FOR COMPUTER-ASSISTED SYSTEMS,” which is incorporated herein by reference.

In some examples, the repositionable structure includes a base manipulator and multiple instrument manipulators coupled to the base manipulator. In some examples, the repositionable structure includes a single instrument manipulator and no serial coupling of manipulators. In some examples, the repositionable structure includes a single instrument manipulator coupled to a single base manipulator. In some examples, the computer-assisted system can include a moveable-base that is cart-mounted or mounted to an operating table, and one or more manipulators mounted to the moveable base.

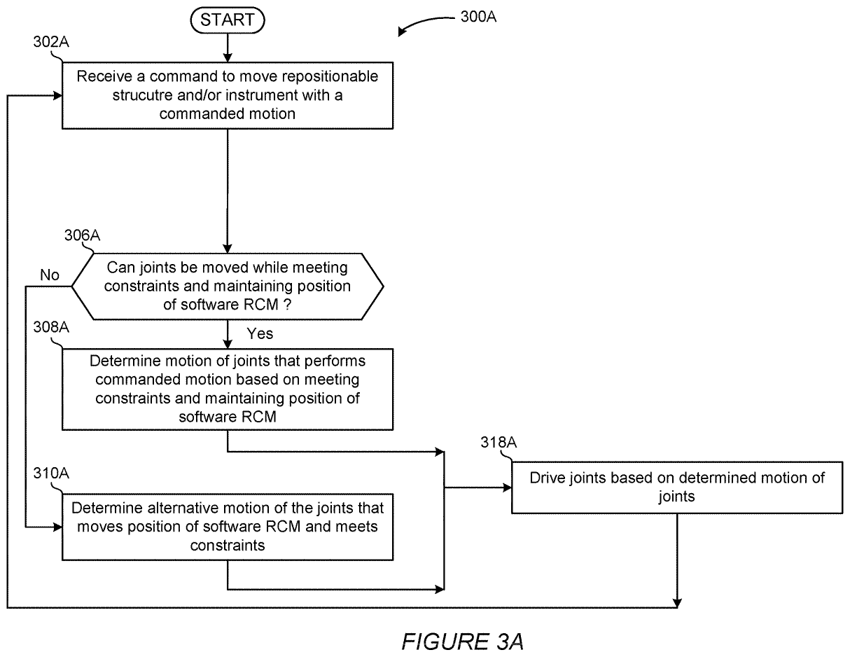

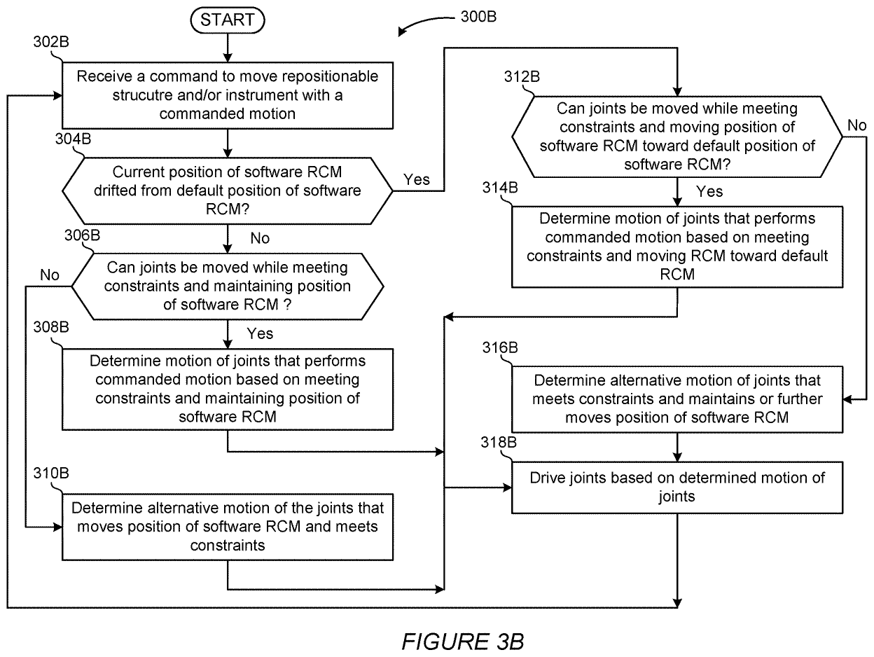

FIG. 3A is a flow diagram of method steps for moving a software RCM with a plastic kinematic constraint and associated with a repositionable structure in accordance with one or more embodiments. Although the method steps are described in conjunction with the systems of FIGS. 1-2 and 4A-5D, persons of ordinary skill in the art will understand that any system configured to perform the method steps, in any order, is within the scope of the present disclosure. One or more of the processes 302A-318A of method 300A can be implemented, at least in part, in the form of executable code stored on non-transient, tangible, machine-readable media. This executable code, when executed by one or more processors (e.g., the processor system 150 in the control unit 140), can cause the one or more processors to perform one or more of the processes 302A-318A. In some embodiments, method 300A can be performed by a module, such as the control module 170. In some embodiments, method 300A can be used by a repositionable structure of a computer-assisted system to employ a software RCM. In some embodiments, the repositionable structure has a default RCM that is a hardware RCM (an RCM enforced by the mechanical design of the repositionable structure, and computer-assisted system may set the RCM at the hardware RCM or at a different position from the hardware RCM). In some embodiments, the repositionable structure does not have a default RCM that is a hardware RCM. Prior to and/or during a procedure, the operator 298 is able to select a software RCM, such as by setting a position of the software RCM, and use the software RCM as a position in the workspace about which one or more instruments supported by the repositionable structure are to be pivoted during teleoperated, semi-autonomous, or autonomous motion.

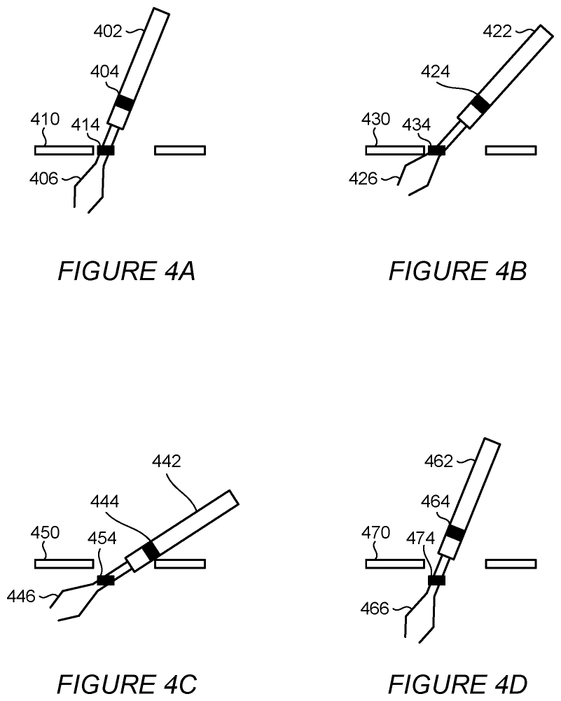

Aspects of method 300A are described via reference to FIGS. 4A-4D, which illustrate movement of a software RCM with a plastic kinematic constraint in accordance with one or more embodiments. However, it is understood that the examples of FIGS. 4A-4D are not restrictive, and that other values, shapes, behaviors, and/or the like depicted in FIGS. 4A-4D may be different for different input devices, different repositionable structures, different follower instruments, different DOFs, different procedures, and/or the like.

At a process 302A, a control module, such as control module 170, receives a command to move a repositionable structure with a commanded motion. The command can be a direct command for the commanded motion of the repositionable structure. Alternatively, the command can be to move a component (such as an instrument) supported by the repositionable structure (e.g., to move an end effector of the instrument), from which corresponding commanded movement of the supporting repositionable structure can be derived. The control module 170 receives the command while the software RCM is set at a first position. The control module 170 can receive the command via any technically feasibly techniques, such as by detecting an input from one or more input devices, in response to being manipulated by the operator 298, receiving an input (e.g., a command) from a semi-autonomous or autonomous software application executed by one or more processors (e.g., the processor system 150 in the control unit 140, the control module 170 itself, etc.), and/or the like. The control module 170 can operate in teleoperated mode, in semi-autonomous, or autonomous mode. The control module 170 can operate in a single mode during a procedure or may switch among multiple modes during a procedure. In teleoperated mode, the control module 170 receives the command from the operator 298 via one or more input devices. For example, the input devices can be contacted and manipulated by the hands of the operator 298, such as with one input device for each hand. Depending upon the implementation, the pose of the input device and the current velocity of the input device can include one or more pose variables corresponding to the positional and/or orientational DOFs of the input device. In semi-autonomous mode, the control module 170 receives commands from a software application executed by one or more processors as well as from the operator 298 via one or more input devices. In some examples, the control module 170 can receive commands from the operator 298 during certain steps of the procedure and received commands from the software application during certain other steps of the procedure. Additionally or alternatively, the control module 170 can receive commands from the software application, where the operator 298 can override the software application and generate commands via one or more input devices. During autonomous operation, the control module 170 generally receives commands from the software application during the entire procedure.

At a process 306A, the control module 170 determines whether the joints can be moved while meeting constraints and/or limits of the repositionable structure and maintaining the current position of the software RCM.

In some examples, the repositionable structure is constrained and/or limited from moving as needed in order to execute the commanded motion while maintaining the position of the software RCM. For example, one or more joints of the repositionable structure are constrained and/or limited by a range of motion (ROM) limit due to physical limitations of the repositionable structure. In other examples, motion of the repositionable structure is constrained so as to avoid collision with nearby objects, such as components, devices, and/or personnel, to avoid keep-out zones, and so on. In such examples, the repositionable structure may become unable to maintain the software RCM at the desired position without violating a constraint and/or limit of the repositionable structure. If the joints can be moved while meeting constraints and/or limits of the repositionable structure and maintaining the current position of the software RCM, then method 300A proceeds to process 308A.

At a process 308A, the control module 170 determines a motion of joints of the repositionable structure that performs the commanded motion while meeting constraints and/or limits of the repositionable structure and while maintaining the position of the software RCM. In some examples, the control module 170 determines the motion of joints based on one or more kinematic models of the repositionable structure. In order to achieve little to no motion of a software RCM as the computer-aided system is moved, one or more joints of a repositionable structure move as needed to maintain the position of the software RCM.

In some examples, the allowed movement of the software RCM can be plastic, whereby control module 170 is configured such that the software RCM remains at the new position of the RCM even when the commands would allow the repositionable structure to move the software RCM toward the default position of the RCM without violating the relevant constraint and/or limit, or even when the repositionable structure is able to achieve a commanded motion while moving the RCM toward a default RCM position. In that regard, FIGS. 4A-4D illustrate movement of a software RCM with a “plastic” kinematic constraint in accordance with one or more embodiments. In this example, the control module 170 moves software RCM from the current position when a commanded motion cannot move one or more instruments so as to reach a desired pose while maintaining the software RCM due to constraints and/or limits of the repositionable structure. As shown in FIG. 4A, a portion of a repositionable structure 402 includes a default RCM located at position 404 and a software RCM located at position 414. In this example, the software RCM located at position 414 has been placed at the entry of a workspace 410 and one or more instruments 406 are installed in the portion of the repositionable structure 402. As shown in FIG. 4B, the control module 170 has moved and rotated the portion of the repositionable structure 422 such that the one or more instruments 426 are near the entry of the workspace 430. Although, in the change from FIG. 4A to 4B, the default RCM 424 has moved from position 404 to 424, the software RCM's current position 434 has remained in the same position as the software RCM's position 414 shown in FIG. 4A. Continuing in this example, method 300A then proceeds to process 318A where the joints of the repositionable structure are driven based on the determined motion of the joints. The commanded motion can be received from an operator, generated autonomously or semi autonomously by the system, etc. relative to its position shown in FIG. 4A.

Returning to the discussion of process 306A, if the joints cannot be moved while meeting constraints and/or limits of the repositionable structure and maintaining the current position of the software RCM, then method 300A proceeds to process 310A. At a process 310A, the control module 170 determines an alternative motion of the joints of the repositionable structure that moves the RCM and meets constraints and/or limits of the repositionable structure. The alternative motion of the joints can move the software RCM from a current position to a new position.

As shown in FIG. 4C, the control module 170 has moved and further rotated the portion of the repositionable structure 442, thereby moving both the default RCM 444 and the software RCM 454. The control module 170 further generates an output directed towards the operator 298 to notify the operator of the movement of the software RCM 454. The output can include a visual indication on a user interface, an audio output, a haptic output, and/or the like. Alternatively, in some examples, the control module 170 can move the software RCM 454 relative to the entry of the workspace 450 while refraining from generating an output directed towards the operator 298 to notify the operator of the movement of the software RCM 454. The control module 170 can move the software RCM 454 in situations where maintaining the current software RCM 454 while moving the joints according to the commanded motion would violate a constraint and/or limit of the repositionable structure 442, as described in conjunction with processes 306A and 308A. In some examples, a constraint and/or limit of the repositionable structure 442 occurs when the repositionable structure 442 is at a range of motion limit, when the repositionable structure 442 is in danger of a collision, when a portion of the repositionable structure 442 would enter a keep-out zone, and/or the like. The control module 170 allows software RCM 454 to move and “drift” due to the motion that cannot be compensated by the limit imposed on the repositionable structure 442. Instead, the control module 170 drives the repositionable structure 442 in a manner that allows the position of the software RCM 454 to move so that the repositionable structure 442 can move the one or more instruments 446 according to the commanded motion while meeting the constraints and/or limits of the repositionable structure 442.

As shown in FIG. 4D, when the repositionable structure is no longer at, or is being moved away from, the constraint and/or limit, the control module 170 maintains the software RCM 474 at the current position, that is, the drifted position of the software RCM 474. The control module 170 has moved the portion of the repositionable structure 462, thereby moving the default RCM 464. Even though the one or more instruments 466 are relatively far away from the material near the entry of the workspace 470, the control module 170 maintains the software RCM 474 at the same position relative to the position of the software RCM 454 of FIG. 4C.

In some examples, the alternative motion can include moving a joint to the range of motion limit or holding the joint at the range of motion limit. Additionally or alternatively, the alternative motion can include moving the repositionable structure to within a predetermined clearance of the physical constraint, or holding the repositionable structure at the predetermined clearance of the physical constraint. The control module 170 can allow software RCM to move when one or more joints of the repositionable structure are at a limit without interrupting the operator 298, such as by allowing the software RCM to move (e.g., to “drift”) due to a motion that cannot be compensated by one or more joints of the repositionable structure that are at a limit. Additionally or alternatively, if the motion of the joints violates a constraint and/or limit of the repositionable structure, then the control module 170 could perform a corrective action. One approach for responding to any of these one or more joints of the repositionable structure being thus constrained and/or limited (e.g., due to reaching a ROM limit, for collision avoidance, to stay out of keep-out zones, etc.) is to not carry out, and discard, the commanded motion from the operator. In some instances, not carrying out the commanded motion, such as by discarding part or all of the commanded motion, can reduce the precision or accuracy of system movement, delay or impede tasks, or increase the likelihood of erroneous movement. Such can also confuse or frustrate the human operator and/or be otherwise undesirable.

In some examples, if the operator 298, via an input control, commands the computer-aided system to perform a motion that would require any of the one or more joints of the repositionable structure to move beyond a constraint and/or limit, then the control module 170 does not carry out that commanded motion. Instead, the control module 170 can carry out only part of the commanded motion (e.g., as much of the commanded motion as possible while maintaining the position of the software RCM without violating the limit).

Alternatively, the control module 170 can disallow and/or discard the entire commanded motion. The control module 170 can optionally transmit feedback to notify the human operator, such as haptic feedback, audible feedback, visual feedback, and/or the like, to indicate the occurrence of this event and provide information such as the amount of deviation of the commanded motion relative to the actual motion of the joints of the repositionable structure. In some instances, such a technique of not carrying out the motion is sufficient and effective, and can better maintain the software RCM.

In some instances, not carrying out the commanded motion, such as by discarding part or all of the commanded motion, can reduce the precision or accuracy of system movement, delay or impede tasks, or increase the likelihood of erroneous movement. Such can also confuse or frustrate the human operator and/or be otherwise undesirable. Further, in some examples, some movement of the software RCM can be tolerable. In such cases, an alternate approach provides the ability to allow some corresponding movement of the software RCM when the repositionable structure reaches a constraint and/or limit, such as one imposed by a ROM limit or an obstacle. In such cases, the control module 170 would drive the joints of the repositioning structure in order to try to maintain the position of a point closest to the default RCM chosen by the operator 298, effectively moving the software RCM.

In some examples, the control module 170 is configured to balance motion of joints of the repositionable structure and the motion of the software RCM. In an example of a repositionable structure with redundant degrees of freedom, the joints of the repositionable structure provide sufficient degrees of freedom to allow a range of joint states (e.g., joint positions, joint velocities, and/or the like) of the plurality of joints for a same state (e.g., position, orientation, velocity, and/or the like) of a distal portion of the repositionable structure, or a portion of an instrument supported by the repositionable structure such as an end effector of the instrument. As a result, in an example with a repositionable structure having a plurality of joints that provide at least one redundant degree of freedom, a commanded motion of the distal portion or the portion of the instrument can often be achieved by different joint movements of the plurality of joints of the repositionable structure (the differences being in the null-space of the repositionable structure). These different joint movements may involve different RCM movements. Thus, in systems where multiple (e.g., two, three, or more) possible joints movements of the repositionable structure can effect a same commanded motion (e.g., of the distal portion, or a portion of the instrument such as the end effector), the control module 170 can be configured to calculate or select the joint motion which results in a smaller (or larger) movement of the software RCM, and/or slower (or faster) movement of the software RCM, and/or the like. The control module 170 may be configured to make such calculation or selection in the null-space by minimizing cost equations, utilizing vector fields urging the solution toward the preferred positions or velocities of the RCM, and/or the like.

Additionally or alternatively, in systems where multiple (e.g., two, three, or more) possible joint motions of a plurality of joints of the repositionable structure achieve the primary objective (e.g., cause the commanded motion of the distal portion, or a portion of the instrument such as the end effector) while producing a same state of the software RCM (e.g., maintaining the position of software RCM, or while producing a same movement of the software RCM, etc.), then the control module 170 can be configured to calculate or select the joint motions which result in smaller (or larger) motion of one or more joints of the repositionable structure, and/or slower (or faster) motions of one or more joints of the repositionable structure, and/or the like.

Additionally or alternatively, the control module 170 can calculate or select joint movements based on determining a result of a cost function structured for determining joint movement within a null space based on one or multiple of the above objectives and/or other objectives. As examples of balancing different objectives, the control module 170 can calculate or select a motion that does not minimize drift of a software RCM, but does decrease the motion and/or speed of links and/or joints of the repositionable structure. Additionally or alternatively, the control module 170 can calculate or select a motion that results in a lower power consumption relative to another motion. Additionally or alternatively, the control module 170 can select a joint motion that results in a lower speed of the repositionable structure relative to another joint motion. Additional discussion of null-space and use of null-space can be found in PCT publication WO 2006/124390 A2 “Software center and highly configurable robotic systems for surgery and other uses” and WO 2014/146095 A1 “System and methods for managing multiple null-space objectives and SLI behaviors.”

In some examples, the allowed movement of the software RCM can be the same across some or all of the received commands or can be different between some or all of these commands. The differentiation may be based on any appropriate criteria, such as the source of command, the direction of movement, the magnitude of the movement, the component moved, etc. For example, the control module 170 can be configured to allow a greater amount of movement of the software RCM (relative to the current position of the software RCM or a default position of the RCM) for teleoperation commands than for one or more other types of commands. Examples of other types of commands include: movement commands autonomously generated by the system, movement commands semi-autonomously generated by the system, and movement commands based on external manipulation applied to the repositionable structure. As another example, the control module 170 can be configured to allow a lesser amount(s) of movement of the software RCM (relative to the current position of the software RCM or a default position of the RCM for commanded movements for automated tasks and/or for one or more external manipulations received on the manipulator arm or other portion of the repositionable structure. These amounts can be lesser compared to other types of commanded movement, such as commanded movement for teleoperation. These lesser amounts can be the same amount across multiple types of movement, or differ based on criteria such as the source of the movement command. In some cases, the control module 170 can disallow any movement of the software RCM (relative to the current position of the software RCM) for movement commands for automated tasks and/or external manipulations, and effectively hold the location of the software RCM unchanged from its current position in response to these type of movement commands. In some examples, the control module 170 can generate movement commands for the manipulator arm or other portion of the repositionable structure for one or more various reasons. Examples of such reasons include generating movement commands in response to: user input signals received at the input control to teleoperate the manipulator arm, the system performing an automated and/or semi-automated movement (e.g., auto-suturing, auto-positioning, and/or the like), external manipulation received on the manipulator arm (e.g., during a “clutch” mode when an operator 298 physically moves the manipulator arm), and/or the like.

In some examples, the magnitude of the drift in the position of the software RCM from the default position of the RCM can be limited. The maximum distance or magnitude of the drift can be a function of the distance between the current software RCM and the default RCM. Additionally or alternatively, the maximum distance or magnitude of the drift can be a function of the magnitude of the motion commanded by the operator 298 in the direction that would violate the limit. Additionally or alternatively, the maximum distance or magnitude of the drift can be a function of the pitch and yaw angles of the repositionable structure relative to the software RCM when the control module 170 begins the drifting of the software RCM. Additionally or alternatively, the maximum distance or magnitude of the drift can be a function of the operator 298 imposing a maximum distance or magnitude of drift that is smaller than physically possible based on the procedure being performed, an operating mode of the repositionable structure, the preference of the operator 298, and/or the like.

If the magnitude of the drift in the position of the software RCM for the default position of the software RCM reaches the maximum allowable distance or magnitude of drift, then the control module 170 can perform one or more remedial actions. In that regard, the control module 170 can discard additional commanded motion after the magnitude of the drift that would have exceeded the maximum allowable distance or magnitude of drift. Additionally or alternatively, the control module 170 can transmit feedback (e.g., haptic, audible, or visual feedback) to the operator 298 if the magnitude of the maximum allowable distance or magnitude of drift is reached. Additionally or alternatively, the control module 170 can allow the operator 298 to increase the magnitude of the maximum allowable distance or magnitude of drift. The increase in magnitude can be temporary (e.g., for a predetermined period of time, for a particular maneuver, until no longer at the maximum allowable distance or magnitude of drift, and/or the like) or permanent (e.g., until increased or decreased by the operator 298).

Upon determining an alternative motion of the joints of the repositionable structure that moves the RCM and meets constraints and/or limits of the repositionable structure, method 300A proceeds to process 318A, where the joints of the repositionable structure are driven based on the determined motion of the joints.

At a process 318A, the control module 170 drives the joints of the repositionable structure based on the determined motion of joints. In some embodiments, the control module 170 drives the joints by sending one or more commands or signals to actuators and/or control systems for controlling each of the joints. Method 300A then proceeds to process 302A to receive and process additional commanded motions.

FIG. 3B is a flow diagram of method steps for moving a software RCM with an elastic kinematic constraint and associated with a repositionable structure in accordance with one or more embodiments. Although the method steps are described in conjunction with the systems of FIGS. 1-2 and 4A-5D, persons of ordinary skill in the art will understand that any system configured to perform the method steps, in any order, is within the scope of the present disclosure. One or more of the processes 302B-318B of method 300B can be implemented, at least in part, in the form of executable code stored on non-transient, tangible, machine-readable media. This executable code, when executed by one or more processors (e.g., the processor system 150 in the control unit 140), can cause the one or more processors to perform one or more of the processes 302B-318B. In some embodiments, method 300B can be performed by a module, such as the control module 170. In some embodiments, method 300B can be used by a repositionable structure of a computer-assisted system to employ a software RCM. In some embodiments, the repositionable structure has a default RCM that is a hardware RCM (an RCM enforced by the mechanical design of the repositionable structure, and computer-assisted system may set the RCM at the hardware RCM or at a different position from the hardware RCM). In some embodiments, the repositionable structure does not have a default RCM that is a hardware RCM. Prior to and/or during a procedure, the operator 298 is able to select a software RCM, such as by setting a position of the software RCM, and use the software RCM as a position in the workspace about which one or more instruments supported by the repositionable structure are to be pivoted during teleoperated, semi-autonomous, or autonomous motion.

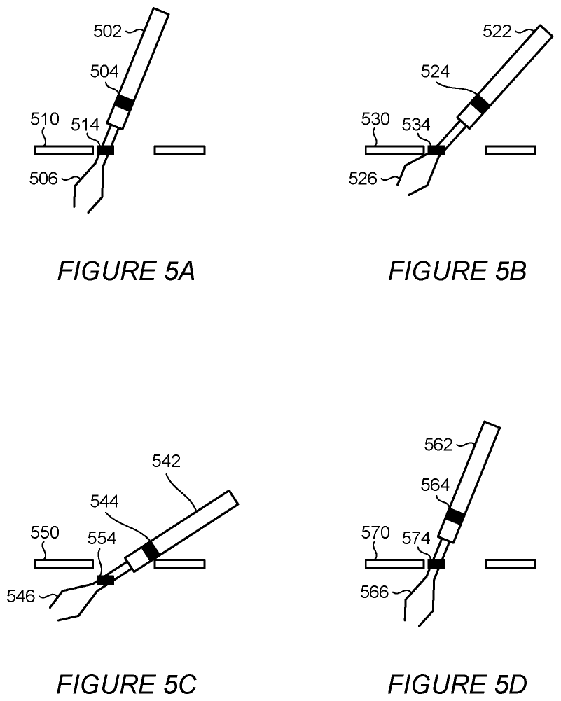

Aspects of method 300B are described via reference to FIGS. 5A-5D, which illustrate movement of a software RCM with an elastic kinematic constraint in accordance with one or more embodiments. However, it is understood that the examples of FIGS. 5A-5D are not restrictive, and that other values, shapes, behaviors, and/or the like depicted in FIGS. 5A-5D may be different for different input devices, different repositionable structures, different follower instruments, different DOFs, different procedures, and/or the like.

At a process 302B, a control module, such as control module 170, receives a command to move a repositionable structure with a commanded motion. The command can be a direct command for the commanded motion of the repositionable structure. Alternatively, the command can be to move a component (such as an instrument) supported by the repositionable structure (e.g., to move an end effector of the instrument), from which corresponding commanded movement of the supporting repositionable structure can be derived. The control module 170 receives the command while the RCM is set at a first position. The control module 170 can receive the command via any technically feasibly techniques, such as by detecting an input from one or more input devices, in response to being manipulated by the operator 298, receiving an input from a semi-autonomous or autonomous software application executed by one or more processors (e.g., the processor system 150 in the control unit 140, the control module 170 itself, etc.), and/or the like. The control module 170 can operate in teleoperated mode, in semi-autonomous, or autonomous mode. The control module 170 can operate in a single mode during a procedure or may switch among multiple modes during a procedure. In teleoperated mode, the control module 170 receives the command from the operator 298 via one or more input devices. For example, the input devices can be contacted and manipulated by the hands of the operator 298, such as with one input device for each hand. Depending upon the implementation, the pose of the input device and the current velocity of the input device can include one or more pose variables corresponding to the positional and/or orientational DOFs of the input device. In semi-autonomous mode, the control module 170 receives commands from a software application executed by one or more processors as well as from the operator 298 via one or more input devices. In some examples, the control module 170 can receive commands from the operator 298 during certain steps of the procedure and received commands from the software application during certain other steps of the procedure. Additionally or alternatively, the control module 170 can receive commands from the software application, where the operator 298 can override the software application and generate commands via one or more input devices. During autonomous operation, the control module 170 generally receives commands from the software application during the entire procedure.

At a process 304B, the control module 170 determines whether a current position of the software RCM has been allowed to drift or move away from a first position (e.g., a “default” position) for the RCM and elastic mode is enabled. In some embodiments, this first position can be a default position for the RCM set for the repositionable structure. In some instances, example default positions for the RCM that is used by the repositionable structure where the software RCM is not set, or when the software RCM is set with no deviation from a hardware RCM of the repositionable structure (for the repositionable structures with hardware RCMs). In some instances, example default positions for the RCM include a prior position for the software RCM. In the examples described in conjunction with FIGS. 3A and 4A-4D, the control module 170 operates in a “plastic” mode. In the examples described in conjunction with FIGS. 3B and 5A-5D, the control module 170 operates in an “elastic” mode. A computer-assisted system may be implemented with no plastic mode and no elastic mode, with plastic mode and without elastic mode, without plastic mode and with elastic mode, and with both plastic and elastic modes. In both the plastic mode and the elastic mode, the control module 170 can move the software RCM from the default position to a new position in order to perform the commanded motion. In the elastic mode, as the control module 170 receives subsequent commands, the control module 170 selectively moves the current position of the software RCM towards the default position of the software RCM when the current position of the software RCM has been allowed to drift or move away from the default position of the software RCM. In that regard, FIGS. 5A-5D illustrate movement of a software RCM with an elastic kinematic constraint, as is described in further detail below. By contrast, in plastic mode, the control module 170 can move the software RCM from the default position to a new position in order to perform the commanded motion, however, as the control module 170 receives subsequent commands, the control module 170 maintains the current position of the software RCM when the current position of the software RCM has been allowed to drift or move away from the default position of the software RCM. In that regard, FIGS. 4A-4D illustrate movement of a software RCM with a plastic kinematic constraint, as is described in further detail below.

If the current position of the software RCM has not drifted from the default position of the software RCM, then method 300B proceeds to process 306B.

At a process 306B, the control module 170 determines whether the joints can be moved while meeting constraints and/or limits of the repositionable structure and maintaining the current position of the software RCM.

In some examples, the repositionable structure is constrained and/or limited from moving as needed in order to execute the commanded motion while maintaining the position of the software RCM. For example, one or more joints of the repositionable structure are constrained and/or limited by a range of motion (ROM) limit due to physical limitations of the repositionable structure. In other examples, motion of the repositionable structure is constrained so as to avoid collision with nearby objects, such as components, devices, and/or personnel, to avoid keep-out zones, and so on. In such examples, the repositionable structure may become unable to maintain the software RCM at the desired position without violating a constraint and/or limit of the repositionable structure. If the joints can be moved while meeting constraints and/or limits of the repositionable structure and maintaining the current position of the software RCM, then method 300B proceeds to process 308B.

At a process 308B, the control module 170 determines a motion of joints of the repositionable structure that performs the commanded motion while meeting constraints and/or limits of the repositionable structure and while maintaining the position of the software RCM. In some examples, the control module 170 determines the motion of joints based on one or more kinematic models of the repositionable structure. In order to achieve little to no motion of a software RCM as the computer-aided system is moved, one or more joints of a repositionable structure move as needed to maintain the position of the software RCM.

In some examples, the allowed movement of the software RCM can be elastic, whereby the control module 170 is configured such that the software RCM returns toward the default position of the RCM when the commands allow the repositionable structure to move the software RCM toward the default position of the RCM without violating the relevant constraint and/or limit. In that regard, FIGS. 5A-5D illustrate movement of a software RCM with an elastic kinematic constraint in accordance with one or more embodiments. In some examples, the control module 170 moves software RCM from the current position when a commanded motion cannot move the repositionable structure and/or one or more instruments as to reach a desired pose while maintaining the software RCM due to constraints and/or limits of the repositionable structure. As shown in FIG. 5A, a portion of a repositionable structure 502 includes a default RCM located at position 504 and a software RCM located at default position 514. In this example, the software RCM located at position 514 has been placed at the entry of a workspace 510 and one or more instruments 506 are installed in the portion of the repositionable structure 502. As shown in FIG. 5B, the control module 170 has moved and rotated the portion of the repositionable structure 522 such that the one or more instruments 526 is near the entry of the workspace 530. Although, in the change from FIG. 5A to 5B, the default RCM has moved from position 504 to 524, the software RCM's current position 534 has remained in the same position as the software RCM's default position 514 shown in FIG. 5A. As shown in this example of FIGS. 5A to 5B, when the system receives a command motion to move from the pose of FIG. 5A to the pose of FIG. 5B, the control module 170 is able to move the repositionable structure 522 and/or the one or more instruments 526 according to the commanded motion without modification of the commanded motion and without moving the position of the software RCM. This is the case even though the repositionable structure may be at a constraint and/or limit in the pose of FIG. 5B. Continuing in this example, method 300B then proceeds to process 318B where the joints of the repositionable structure are driven based on the determined motion of the joints. The commanded motion can be received from an operator, generated autonomously or semi autonomously by the system, etc. relative to its position shown in FIG. 5A.

Returning to the discussion of process 306B, if the joints cannot be moved while meeting constraints and/or limits of the repositionable structure and maintaining the current position of the software RCM, then method 300B proceeds to process 310B. At a process 310B, the control module 170 determines an alternative motion of the joints of the repositionable structure that moves the RCM and meets constraints and/or limits of the repositionable structure. The alternative motion of the joints can move the software RCM from a current position to a new position.

As shown in FIG. 5C, the control module 170 has moved and further rotated the portion of the repositionable structure 542, thereby moving both the default RCM 544 and the software RCM 554. The control module 170 can move a position of the software RCM 554 relative to the entry of the workspace 550. (As used herein, “moving” the RCM is used to express moving a position of an RCM.) The control module 170 may refrain from generating an output directed towards the operator 298 to notify the operator of the movement of the software RCM 554, or generate such an output to notify the operator 298 of the movement of the software RCM 554 contemporaneously with or after such RCM 554 movement. The control module 170 can move the software RCM 554 in situations where maintaining the current software RCM 554 while moving the joints according to the commanded motion would violate a constraint and/or limit of the repositionable structure 542, as described in conjunction with processes 306B and 308B. In some examples, a constraint and/or limit of the repositionable structure 542 occurs when the repositionable structure 542 is at a range of motion limit, when the repositionable structure 542 is in danger of a collision, when a portion of the repositionable structure 542 would enter a keep-out zone, and/or the like. The control module 170 allows software RCM 554 to move and “drift” due to the motion that cannot be compensated by the limit imposed on the repositionable structure 542. Instead, the control module 170 drives joints of the repositionable structure 542 in a manner that allows the position of the software RCM to move so that the repositionable structure can move the one or more instruments 546 according to the commanded motion while meeting the constraints and/or limits of the repositionable structure 542.

In some examples, the alternative motion can include moving a joint to the range of motion limit or holding the joint at the range of motion limit. Additionally or alternatively, the alternative motion can include moving the repositionable structure to within a predetermined clearance of the physical constraint, or holding the repositionable structure at the predetermined clearance of the physical constraint. The control module 170 can allow software RCM to move when one or more joints of the repositionable structure are at a limit without interrupting the operator 298, such as by allowing the software RCM to move (e.g. to “drift”) due to a motion that cannot be compensated by one or more joints of the repositionable structure that are at a limit. Additionally or alternatively, if the motion of the joints violates a constraint and/or limit of the repositionable structure, then the control module 170 could perform a corrective action. One approach for responding to any of these one or more joints of the repositionable structure being thus constrained and/or limited (e.g., due to reaching a ROM limit, for collision avoidance, to stay out of keep-out zones, etc.) is to not carry out, and discard, the commanded motion from the operator. In some instances, not carrying out the commanded motion, such as by discarding part or all of the commanded motion, can decrease the accuracy or precision in the movement of the repositionable structure or any components (e.g., instruments) supported by the repositionable structure, and can increase the frequency or magnitude of erroneous movement. Such can confuse or frustrate the human operator and/or be otherwise undesirable.

In some examples, if the operator 298, via an input control, commands the computer-aided system to perform a motion that would require any of the one or more joints of the repositionable structure to move beyond a constraint and/or limit, then the control module 170 does not carry out that commanded motion. Instead, the control module 170 can carry out only part of the commanded motion (e.g., as much of the commanded motion as possible while maintaining the position of the software RCM without violating the limit).

Alternatively, the control module 170 can disallow and/or discard the entire commanded motion. The control module 170 can optionally transmit feedback to notify the human operator, such as haptic feedback, audible feedback, visual feedback, and/or the like, to indicate the occurrence of this event and provide information such as the amount of deviation of the commanded motion relative to the actual motion of the joints of the repositionable structure. In some instances, such a technique of not carrying out the motion is sufficient and effective, and can better maintain the software RCM.

In some instances, not carrying out the commanded motion, such as by discarding part or all of the commanded motion, can reduce the precision or accuracy of system movement, delay or impede tasks, or increase the likelihood of erroneous movement. Such can also confuse or frustrate the human operator and/or be otherwise undesirable. Further, in some examples, some movement of the software RCM can be tolerable. In such cases, an alternate approach provides the ability to allow some corresponding movement of the software RCM when the repositionable structure reaches a constraint and/or limit, such as one imposed by a ROM limit or an obstacle. In such cases, the control module 170 would drive the joints of the repositioning structure in order to try to maintain the position of a point closest to the default RCM chosen by the operator 298, effectively moving the software RCM.

In some examples, the control module 170 is configured to select among possible motions of joints of the repositionable structure, select among possible motions of the software RCM, or select a combination of possible motions of joints of the repositionable structure and the software RCM. In an example, the plurality of joints of a repositionable structure with redundant degrees of freedom for moving distal portion of the repositionable structure, or a portion of an instrument supported by the repositionable structure such as an end effector of the instrument. The joints of the repositionable structure provide sufficient degrees of freedom to allow a range of joint states (e.g., joint positions, joint velocities, and/or the like) of the plurality of joints for a same state (e.g., position, orientation, velocity, and/or the like) of the distal portion of the repositionable structure, or the portion of the instrument supported by the repositionable structure. In this example, a commanded motion of the distal portion or the portion of the instrument can often be achieved with multiple, different movements of the plurality of joints of the repositionable structure. In robotics, these different movements are often expressed as being in the null-space of the Jacobian of the plurality of joints of the repositionable structure. In this example, these different joint movements may involve different RCM movements or positions. Thus, in systems with such redundant degrees of freedom, the control module 170 can be configured to calculate or select the joint movements for achieving additional objectives. Example additional objectives involving the RCM include smaller (or larger) movements of the software RCM along one or more dimensions, and/or slower (or faster) movement of the software RCM along or more dimensions, and/or the like. The control module 170 may be configured to make such calculation or selection in the null-space by minimizing cost functions, utilizing vector fields urging the solution toward the preferred positions or velocities of the RCM, and/or the like.

Additionally or alternatively, in such systems with redundant degrees of freedom, the control module 170 can be configured to calculate or select the joint motions for achieving objectives not specific to RCM position or motion. Other objectives include collision avoidance, increasing resulting range-of-motion, reducing power consumption, reducing overall speed of one or more links or joints of the repositionable structure, and/or the like.

As a specific example of calculating or select joint movements based on multiple objectives, optimizing a cost function structured for multiple of the above objectives and/or other objectives can be used. For example, a cost function can be structured to balance the change in position or amount of motion of a software RCM, and an amount of motion (e.g., a total displacement, a total path length of movement, a maximum or average speed) of one or more links or joints of the repositionable structure. The control module 170 can be configured to optimizing such a cost function when calculating or selecting joint movements for the plurality of joints of the repositionable structure, and determine joint movement with particular RCM movement and repositionable structure movement characteristics. The cost function can be structured to provide decreased motion of the RCM and reduced speed of the links and/or joints of the repositionable structure, for example. Additional discussion of the null-space of robotic systems with redundant degrees of freedom for various objectives, and the use of such null-space, can be found in the PCT publications referenced herein.

In some examples, the allowed movement of the software RCM can be the same across some or all of the received commands or can be different between some or all of these commands. The differentiation may be based on any appropriate criteria, such as the source of command, the direction of movement, the magnitude of the movement, the component moved, etc. For example, the control module 170 can be configured to allow a greater amount of movement of the software RCM (relative to the current position of the software RCM or a default position of the RCM) for teleoperation commands than for one or more other types of commands. Examples of other types of commands include: movement commands autonomously generated by the system, movement commands semi-autonomously generated by the system, and movement commands based on external manipulation applied to the repositionable structure. As another example, the control module 170 can be configured to allow a lesser amount(s) of movement of the software RCM (relative to the current position of the software RCM or a default position of the RCM for commanded movements for automated tasks and/or for one or more external manipulations received on the manipulator arm or other portion of the repositionable structure. These amounts can be lesser compared to other types of commanded movement, such as commanded movement for teleoperation. These lesser amounts can be the same amount across multiple types of movement, or differ based on criteria such as the source of the movement command. In some cases, the control module 170 can disallow any movement of the software RCM (relative to the current position of the software RCM) for movement commands for automated tasks and/or external manipulations, and effectively hold the location of the software RCM unchanged from its current position in response to these type of movement commands. In some examples, the control module 170 can generate movement commands for the manipulator arm or other portion of the repositionable structure for one or more various reasons. Examples of such reasons include generating movement commands in response to: user input signals received at the input control to teleoperate the manipulator arm, the system performing an automated and/or semi-automated movement (e.g., auto-suturing, auto-positioning, and/or the like), external manipulation received on the manipulator arm (e.g., during a “clutch” mode when an operator 298 physically moves the manipulator arm), and/or the like.

In some examples, the magnitude of the drift in the position of the software RCM from the default position of the RCM can be limited. The maximum distance or magnitude of the drift can be a function of the distance between the current software RCM and the default RCM. Additionally or alternatively, the maximum distance or magnitude of the drift can be a function of the magnitude of the motion commanded by the operator 298 in the direction that would violate the limit. Additionally or alternatively, the maximum distance or magnitude of the drift can be a function of the pitch and yaw angles of the repositionable structure relative to the software RCM when the control module 170 begins the drifting of the software RCM. Additionally or alternatively, the maximum distance or magnitude of the drift can be a function of the operator 298 imposing a maximum distance or magnitude of drift that is smaller than physically possible based on the procedure being performed, an operating mode of the repositionable structure, the preference of the operator 298, and/or the like.

If the magnitude of the drift in the position of the software RCM for the default position of the software RCM reaches the maximum allowable distance or magnitude of drift, then the control module 170 can perform one or more remedial actions. In that regard, the control module 170 can discard additional commanded motion after the magnitude of the drift that would have exceeded the maximum allowable distance or magnitude of drift. Additionally or alternatively, the control module 170 can transmit feedback (e.g., haptic, audible, or visual feedback) to the operator 298 if the magnitude of the maximum allowable distance or magnitude of drift is reached. Additionally or alternatively, the control module 170 can allow the operator 298 to increase the magnitude of the maximum allowable distance or magnitude of drift. The increase in magnitude can be temporary (e.g., for a predetermined period of time, for a particular maneuver, until no longer at the maximum allowable distance or magnitude of drift, and/or the like) or permanent (e.g., until increased or decreased by the operator 298).

Upon determining an alternative motion of the joints of the repositionable structure that moves the RCM and meets constraints and/or limits of the repositionable structure, method 300B proceeds to process 318B, where the joints of the repositionable structure are driven based on the determined motion of the joints.

Returning to the discussion of process 304B, if the current position of the software RCM has been allowed to drift or move away from the default position of the software RCM and if elastic mode is enabled, then method 300B proceeds to process 312B. At a process 312B, the control module 170 determines whether the joints can be moved while meeting constraints and/or limits of the repositionable structure and moving the current position of the software RCM towards the default position of the software RCM. If the joints cannot be moved while meeting constraints and/or limits of the repositionable structure and moving the current position of the software RCM towards the default position of the software RCM, then method 300B proceeds to a process 316B.

At a process 316B, the control module 170 determines an alternative motion of joints of the repositionable structure that meets constraints and/or limits of the repositionable structure and either maintaining the position of the software RCM or further moves the position of the software RCM away from the default position of the software RCM. At a process 318B, the control module 170 drives the joints of the repositionable structure in based on the determined motion of joints. Method 300B then proceeds to process 302B to receive and process additional commanded motions.

Returning to the discussion of process 312B, if the joints can be moved while meeting constraints and/or limits of the repositionable structure and moving the current position of the software RCM towards the default position of the software RCM, then method 300B proceeds to a process 314B. At a process 314B, the control module 170 determines a motion of joints of the repositionable structure that meets constraints and/or limits of the repositionable structure and moves position of the software RCM towards the default position of the software RCM.

As shown in FIG. 5D, when the repositionable structure is no longer at, or is being moved away from, the limit, the control module 170 returns the software RCM 574 to the default position, that is, the default position 514 of the software RCM shown in FIG. 5A. The control module 170 has moved the portion of the repositionable structure 562, thereby moving the default RCM 564 and the software RCM 574. Likewise, the position of the one or more instruments 566 have moved to the default position relative to the material near the entry of the workspace 570 shown in FIG. 5A.

In some examples, when the repositionable structure is no longer at the constraint and/or limit, as in FIG. 5D, the control module 170 can perform multiple operations over a series of steps to iteratively reduce the distance between the current position of the software RCM 574 and the default position 514 of the software RCM. At each step of the iterative reduction operation, the control module 170 determines a difference between the position of the current software RCM 574 and the default position 514 of the software RCM in the world frame. The control module 170 determines whether a motion based on a received input command from the operator 298 allows movement of the software RCM 574. If the movement allows the software RCM 574 to move to a potential position that is closer to the default position 514 of the software RCM (i.e., the difference is smaller than a previous difference), then the control module 170 moves the software RCM 574 based on the movement.

In some examples, the control module 170 receives a command to move the repositionable structure with a commanded motion while the software RCM is at an intermediate position. At this intermediate position of the RCM, the separation distance between the intermediate position of the RCM and the default position of the RCM is less than the separation distance between the moved position of the RCM shown in FIG. 5C and the default position of the RCM. If the control module 170 determines that driving the joints to move the repositionable structure in accordance with the commanded motion would not violate the limit of the repositionable structure, then the control module drives the joints to move the repositionable structure in accordance with the commanded motion while the RCM is at the intermediate position. If the control module 170 determines that driving the joints to move the repositionable structure in accordance with the second commanded motion while the RCM is at the third position would violate the limit of the repositionable structure, then the control module drives the joints to move the repositionable structure in accordance with the commanded motion while maintaining the RCM at the moved position of the RCM shown in FIG. 5C. Method 300B then proceeds to process 318B, where the joints of the repositionable structure are driven based on the determined motion of the joints.

At a process 318B, the control module 170 drives the joints of the repositionable structure based on the determined motion of joints. In some embodiments, the control module 170 drives the joints by sending one or more commands or signals to actuators and/or control systems for controlling each of the joints. Method 300B then proceeds to process 302B to receive and process additional commanded motions.

As discussed above and further emphasized here, FIGS. 3A-3B are merely examples which should not unduly limit the scope of the claims. One of ordinary skill in the art would recognize many variations, alternatives, and modifications. In some embodiments, the control module 170 can determine that the commanded motion should not be allowed or should be allowed only in part. Further in some embodiments, the control module 170 can determine that the computer-assisted system should terminate the procedure and/or exit from teleoperated mode, semi-autonomous, or autonomous mode, as relevant. In some examples, the computer-assisted system can employ certain operational modes that disallow movement of the software RCM from the current position of the software RCM. Such operational modes can be based on the type of instrument being used, the stage in the procedure being performed, input from the operator 298, environmental factors, and/or the like.

In some examples, such as during process 310A of FIG. 3A or process 310B of FIG. 3B, the control module 170 can employ a combination of the disclosed techniques. The control module 170 can move the software RCM using a hybrid of the plastic kinematic constraint approach and the elastic kinematic constraint approach. In such examples, when the repositionable structure is no longer at the constraint and/or limit, the control module 170 can move the software RCM to a position that is in between the current position of the software RCM and the default position of the software RCM before the software RCM was moved. In some examples, the control module 170 can determine that the alternative motion still violates the limit. As a result, the control module 170 can move the software RCM as much as possible without violating the limit and discard a portion of the alternative motion that does violate the limit. The control module 170 can generate feedback to the operator 298 indicating that at least a portion of the commanded motion was discarded.

Some examples of control units, such as the control unit 140 of FIG. 1 can include non-transient, tangible, machine-readable media that include executable code that when executed by one or more processors (e.g., the processor system 150 of FIG. 1) can cause the one or more processors to perform the processes of method 300. Some common forms of machine-readable media that can include the processes of method 300 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

1. A computer-assisted system comprising:
a repositionable structure configured to support an instrument, the repositionable structure comprising a plurality of links coupled by a plurality of joints; and
a control unit communicatively coupled to the repositionable structure, the control unit configured to:
while a remote center of motion (RCM) of the repositionable structure is set at a first position, receive a command to move the repositionable structure with a commanded motion;
determine whether driving the plurality of joints to move the repositionable structure in accordance with the commanded motion while maintaining the remote center of motion RCM at the first position would violate a limit of the repositionable structure;
in response to a determination that driving the plurality of joints to move the repositionable structure in accordance with the commanded motion while maintaining the RCM at the first position would violate the limit:
determine an alternative motion of the plurality of joints based on the commanded motion and the first position, wherein driving the plurality of joints in accordance with the alternative motion would not violate the limit, and would move the RCM to a second position different from the first position, and
drive the plurality of joints in accordance with the alternative motion;
after the RCM has moved from the first position and while the RCM is at a current position, receive a second command to move the repositionable structure with a second commanded motion; and
in response to a determination that driving the plurality of joints to move the repositionable structure in accordance with the second commanded motion allows the RCM to move closer to the first position while not violating the limit, drive the plurality of joints to move the repositionable structure in accordance with the second commanded motion and to move the RCM closer to the first position.

2-3. (canceled)

4. The computer-assisted system of claim 1, wherein the limit comprises:
a range of motion limit of a first joint included in the plurality of joints; or
a physical constraint of the computer-assisted system; or
a motion limit based on a position or a speed of the repositionable structure.

5. The computer-assisted system of claim 1, wherein:
the limit comprises a range of motion limit of a first joint of the plurality of joints, and the alternative motion comprises moving the first joint to the range of motion limit or holding the first joint at the range of motion limit; or
the limit comprises a physical constraint of the computer-assisted system, and the alternative motion comprises moving the repositionable structure to within a predetermined clearance of the physical constraint, or holding the repositionable structure at the predetermined clearance of the physical constraint.

6-9. (canceled)

10. The computer-assisted system of claim 1, wherein the control unit is further configured to: generate feedback to notify an operator in response to moving the RCM to the second position.

11. (canceled)

12. The computer-assisted system of claim 1, wherein the control unit is further configured to, after moving the RCM to the second position:
receive a third command to move the repositionable structure with a third commanded motion; and
drive the plurality of joints to move the repositionable structure in accordance with the third commanded motion while maintaining the RCM at the second position, even if driving the plurality of joints in accordance with a second alternative motion of the plurality of joints would not violate the limit and would move the RCM to the first position or to a third position, the third position being closer to the first position than the second position is close to the first position.

13. The computer-assisted system of claim 1, wherein the control unit is further configured to, after moving the RCM to the second position and receiving a third command to move the repositionable structure with a third commanded motion:
in response to a determination that driving the plurality of joints to move the repositionable structure in accordance with the third commanded motion while moving the RCM closer to the first position would not violate a second limit of the repositionable structure, drive the plurality of joints to move the repositionable structure in accordance with the third commanded motion while moving the RCM closer to the first position; or
in response to a determination that driving the plurality of joints to move the repositionable structure in accordance with the third commanded motion while the RCM is at a third position would not violate the second limit of the repositionable structure, drive the plurality of joints to move the repositionable structure in accordance with the third commanded motion while moving the RCM to the third position, wherein a separation distance between the third position and the first position is less than a separation distance between the second position and the first position.

14. (canceled)

15. The computer-assisted system of claim 13, wherein the control unit is further configured to:
in response to a determination that driving the plurality of joints to move the repositionable structure in accordance with the third commanded motion while the RCM is at the third position would violate the second limit of the repositionable structure, drive the plurality of joints to move the repositionable structure in accordance with the third commanded motion while maintaining the RCM at the second position.

16. (canceled)

17. The computer-assisted system of claim 1, wherein the control unit is further configured to:
in response to a determination that driving the plurality of joints to move the repositionable structure in accordance with the second commanded motion does not allow the RCM to move closer to the first position while not violating the limit, maintain the RCM at the current position.

18. The computer-assisted system of claim 1, wherein the control unit is further configured to:
determine that the second commanded motion allows the RCM to move closer to the first position by: determining that driving the plurality of joints to move the repositionable structure in accordance with the second commanded motion with the RCM at a potential position does not violate the limit, wherein a distance between the potential position and the first position of the RCM is less than a distance between and the current position and the first position.

19. The computer-assisted system of claim 1, wherein the RCM has a default position, and the control unit is further configured to:
move the RCM closer to the first position by moving the RCM by a distance based on a separation distance between the second position and the default position.

20. (canceled)

21. The computer-assisted system of claim 1, wherein the RCM has a default position, and wherein the control unit is further configured to:
limit a distance between the default position and the second position to no more than a maximum distance.

22. The computer-assisted system of claim 21, wherein the control unit is further configured to determine the maximum distance:
based on a procedure being performed by the computer-assisted system; or
based on an operating mode of the repositionable structure, or
such that the maximum distance is greater in response to the command being a teleoperation command than in response to the command being a semi-autonomous or autonomous command, the autonomous command being generated by the computer-assisted system.

23. (canceled)

24. The computer-assisted system of claim 21, wherein the default position is a position of a hardware RCM of the repositionable structure, and wherein one or more joints of the plurality of joints are mechanically constrained to pivot about the hardware RCM.

25. The computer-assisted system of claim 1, wherein the RCM has a default position, and wherein the control unit is further configured to:
cause the repositionable structure to perform a remedial action in response to a distance between the second position and the default position exceeding a maximum distance.

26. The computer-assisted system of claim 25, wherein the remedial action comprises:
discarding an additional commanded motion in response to a determination that driving the plurality of joints in to perform the additional commanded motion would move a current position of the RCM to a distance from the default position exceeding the maximum distance; or
prompting an operator to allow an increase in the maximum distance.

27-28. (canceled)

29. The computer-assisted system of claim 1, wherein the plurality of joints provide sufficient degrees of freedom to allow a range of joint states of the plurality of joints for a same state of an end effector of the instrument, and wherein, to determine the alternative motion of the plurality of joints, the control unit is further configured to:
determine the alternative motion to produce a smaller movement of the RCM, to produce a slower movement of the RCM, to produce less movement of at least one joint of the plurality of joints, or to produce a slower movement of the repositionable structure.

30. (canceled)

31. The computer-assisted system of claim 1, wherein the control unit is further configured to:
disallow movement of the RCM from the first position based on a type of instrument being used by the computer-assisted system, or
disallow movement of the RCM from the first position based on a stage in a procedure being performed by the repositionable structure.

32. A method of driving a plurality of joints of a repositionable structure, the method comprising:
while a remote center of motion (RCM) of the repositionable structure is set at a first position, receiving a command to move an instrument supported by the repositionable structure with a commanded motion;
determining whether driving the plurality of joints to move the repositionable structure in accordance with the commanded motion while maintaining the RCM at the first position would violate a limit of the repositionable structure;
in response to determining that driving the plurality of joints to move the repositionable structure in accordance with the commanded motion while maintaining the RCM at the first position would violate the limit:
determining an alternative motion of the plurality of joints based on the commanded motion and the first position, wherein driving the plurality of joints in accordance with the alternative motion would not violate the limit, and would move the RCM to a second position different from the first position, and
driving the plurality of joints in accordance with the alternative motion;
after the RCM has moved from the first position and while the RCM is at a current position, receiving a second command to move the repositionable structure with a second commanded motion; and
in response to a determination that driving the plurality of joints to move the repositionable structure in accordance with the second commanded motion allows the RCM to move closer to the first position while not violating the limit, driving the plurality of joints to move the repositionable structure in accordance with the second commanded motion and to move the RCM closer to the first position.

33-39. (canceled)

40. The method of claim 32, further comprising, after moving the RCM to the second position:
receiving a third command to move the repositionable structure with a third commanded motion; and
driving the plurality of joints to move the repositionable structure in accordance with the third commanded motion while maintaining the RCM at the second position, even if driving the plurality of joints in accordance with a second alternative motion of the plurality of joints would not violate the limit and would move the RCM to the first position or to a third position, the third position being closer to the first position than the second position is close to the first position.

41. The method of claim 32, further comprising, after moving the RCM to the second position and receiving a third command to move the repositionable structure with a third commanded motion:
in response to a determination that driving the plurality of joints to move the repositionable structure in accordance with the third commanded motion while moving the RCM closer to the first position would not violate a second limit of the repositionable structure, driving the plurality of joints to move the repositionable structure in accordance with the third commanded motion while moving the RCM closer to the first position; or
in response to a determination that driving the plurality of joints to move the repositionable structure in accordance with the third commanded motion while the RCM is at a third position would not violate the second limit of the repositionable structure, drive the plurality of joints to move the repositionable structure in accordance with the third commanded motion while moving the RCM to the third position, wherein a separation distance between the third position and the first position is less than a separation distance between the second position and the first position.

42-44. (canceled)

45. The method of claim 32, further comprising:
in response to a determination that driving the plurality of joints to move the repositionable structure in accordance with the second commanded motion does not allow the RCM to move closer to the first position while not violating the limit, maintaining the RCM at the current position.

46-48. (canceled)

49. The method of claim 32, wherein the RCM has a default position, and further comprising:
limiting a distance between the default position and the second position to no more than a maximum distance.

50-52. (canceled)

53. The method of claim 32, wherein the RCM has a default position, and further comprising:
causing the repositionable structure to perform a remedial action in response to a distance between the second position and the default position exceeding a maximum distance.

54-56. (canceled)

57. The method of claim 32, further comprising:
disallowing movement of the RCM from the first position based on a type of instrument being used by a computer-assisted system, or a stage in a procedure being performed by the repositionable structure.

58. One or more non-transitory machine-readable media comprising a plurality of machine-readable instructions which, when executed by one or more processors associated with a computer-assisted system comprising a repositionable structure, the repositionable structure comprising a plurality of joints, are adapted to cause the one or more processors to perform a method comprising:
while a remote center of motion (RCM) of the repositionable structure is set at a first position, receiving a command to move an instrument supported by the repositionable structure with a commanded motion;
determining whether driving the plurality of joints to move the repositionable structure in accordance with the commanded motion while maintaining the RCM at the first position would violate a limit of the repositionable structure;
in response to determining that driving the plurality of joints to move the repositionable structure in accordance with the commanded motion while maintaining the RCM at the first position would violate the limit:
determining an alternative motion of the plurality of joints based on the commanded motion and the first position, wherein driving the plurality of joints in accordance with the alternative motion would not violate the limit, and would move the RCM to a second position different from the first position, and
driving the plurality of joints in accordance with the alternative motion;
after the RCM has moved from the first position and while the RCM is at a current position, receiving a second command to move the repositionable structure with a second commanded motion; and
in response to a determination that driving the plurality of joints to move the repositionable structure in accordance with the second commanded motion allows the RCM to move closer to the first position while not violating the limit, driving the plurality of joints to move the repositionable structure in accordance with the second commanded motion and to move the RCM closer to the first position.
